(19) United States
(12) Patent Application Publication
(10) Pub. No.: US 2008/0294886 A1
(43) Pub. Date: Nov. 27, 2008

(54) Method for resetting bios

(75) Inventor: Chia-Yi Chang, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: DFI, Inc., Taipei Hsien (TW)

(21) Appl. No.: 11/953,884

(22) Filed: Dec. 11, 2007

(30) Foreign Application Priority Data
May 21, 2007 (TW) 96118073

(51) Int. Cl. G06F 9/00

(52) U.S. Cl. 713/2

(57) ABSTRACT

A method for resetting a basic input/output system (BIOS) suitable for a desktop computer having the BIOS is provided. The BIOS is reset when a reset or power button of the desktop computer is pressed. Accordingly, the problem that the desktop computer cannot be booted up can be resolved quickly.

### CROSS-REFERENCE TO RELATED APPLICATION

This application claims the priority benefit of Taiwan application serial no. 96118073, filed on May 21, 2007. The entirety of the above-mentioned patent application is hereby incorporated by reference herein and made a part of this specification.

### BACKGROUND OF THE INVENTION

1. Field of the Invention

The present invention generally relates to a method for resetting a basic input/output system (BIOS), in particular, to a method for resetting a BIOS suitable for a desktop computer having the BIOS.

2. Description of Related Art

Conventionally, if a desktop computer cannot be booted up, the BIOS of the desktop computer can be reset, namely, discharged, to initialize the value of the BIOS and to boot up the desktop computer.

An existing method for resetting the BIOS of a desktop computer includes following steps. First, the case of the desktop computer has to be dismantled after the desktop computer is shut down. Then, a plurality of pins of the BIOS on the motherboard of the desktop computer has to be found manually. After that, a jumper is placed over two of the pins to ground the BIOS, and accordingly to discharge the BIOS. Thus, the editable data in the BIOS is cleared so that the desktop computer can be booted up normally.

However, according to the method described above, the case of the desktop computer has to be opened and the pins of the BIOS have to be manually found on the motherboard of the desktop computer, therefore the method is very inconvenient and time-consuming.

### SUMMARY OF THE INVENTION

Accordingly, the present invention is directed to a method for resetting a basic input/output system (BIOS) in order to resolve the problem that a desktop computer cannot be booted up.

The present invention is directed to a BIOS reset method for initializing a value of the BIOS.

The present invention further provides a BIOS reset method by which a user can reset the BIOS conveniently.

The present invention provides a method for resetting a BIOS suitable for a desktop computer having the BIOS. The method includes following steps. First, whether the desktop computer is powered off and is supplied with power is determined. Next, whether a reset button of the desktop computer is pressed is determined when the desktop computer is powered off and supplied with power. After that, whether a power button of the desktop computer is pressed is determined when the reset button is pressed. The BIOS is reset when the reset button and the power button are both pressed.

According to an embodiment of the present invention, the step of resetting the BIOS includes loading an initial value into the BIOS.

According to an embodiment of the present invention, the initial value is stored in a south bridge (S/B) controller of the desktop computer.

According to an embodiment of the present invention, whether the reset button is pressed is determined by a decision circuit of the desktop computer.

According to an embodiment of the present invention, whether the power button is pressed is determined by a decision circuit of the desktop computer.

The present invention further provides a method for resetting a BIOS suitable for a desktop computer which is powered off and supplied with power, wherein the desktop computer has the BIOS. The method includes following steps. First, whether a rest button of the desktop computer is pressed is determined. Next, whether a power button of the desktop computer is pressed is determined when the reset button is pressed. After that, the BIOS is reset when the reset button and the power button are both pressed.

According to an embodiment of the present invention, the step of resetting the BIOS includes loading an initial value into the BIOS.

According to an embodiment of the present invention, the initial value is stored in a S/B controller of the desktop computer.

According to an embodiment of the present invention, whether the reset button is pressed is determined by a decision circuit of the desktop computer.

According to an embodiment of the present invention, whether the power button is pressed is determined by a decision circuit of the desktop computer.

The present invention further provides a method for resetting a BIOS suitable for a desktop computer having the BIOS. The method includes resetting the BIOS when a reset button and a power button of the desktop computer are both pressed.

According to an embodiment of the present invention, the step of resetting the BIOS includes loading an initial value into the BIOS.

According to an embodiment of the present invention, the initial value is stored in a S/B controller of the desktop computer.

According to the present invention, the BIOS of a desktop computer is reset when a reset button and a power button of the desktop computer are pressed down. Thus, compared to the prior art, the value of the BIOS can be initialized more conveniently and quickly in the present invention. Accordingly, the problem that the desktop computer cannot be booted up can be resolved.

### BRIEF DESCRIPTION OF THE DRAWINGS

The accompanying drawings are included to provide a further understanding of the invention, and are incorporated in and constitute a part of this specification. The drawings illustrate an embodiment of the invention and, together with the description, serve to explain the principles of the invention.

FIG. 1A is a perspective view of a desktop computer according to an embodiment of the present invention.

FIG. 1B is a flowchart illustrating a method for resetting a basic input/output system (BIOS) according to the embodiment of the present invention.

FIG. 1C is a circuit diagram of the desktop computer in FIG. 1A.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

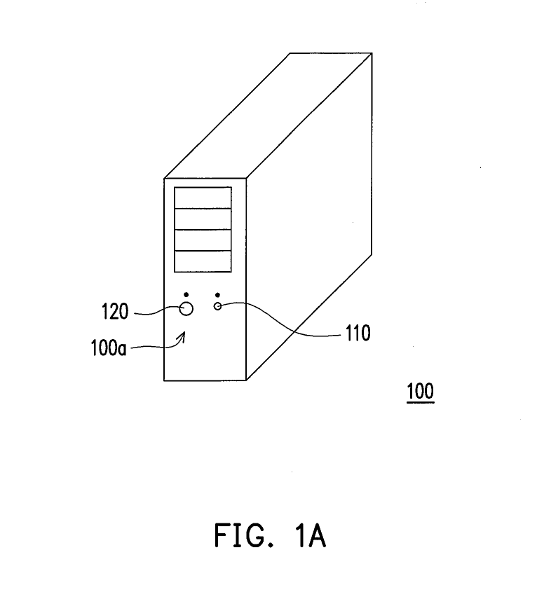

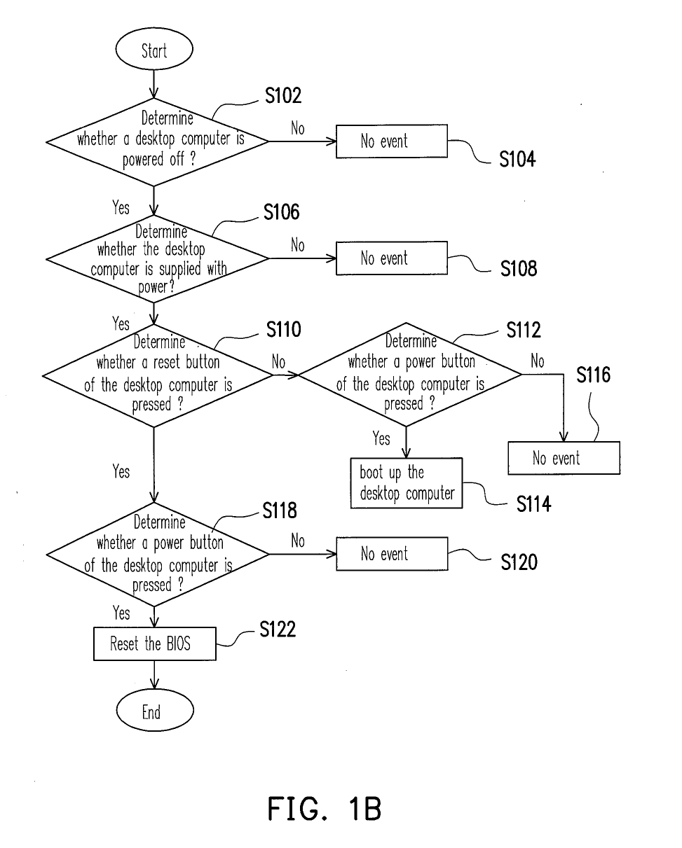

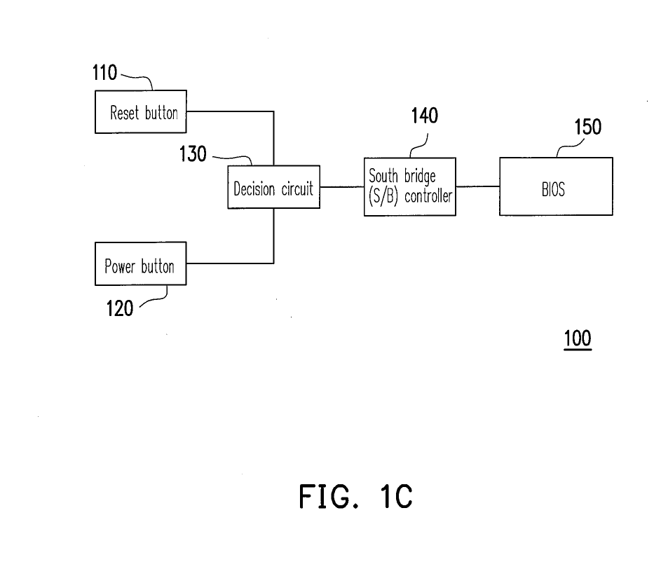

FIG. 1A is a perspective view of a desktop computer according to an embodiment of the present invention, and FIG. 1B is a flowchart illustrating a method for resetting a basic input/output system (BIOS) according to the embodiment of the present invention. Referring to both FIG. 1A and FIG. 1B, in the present embodiment, the BIOS reset method is suitable for a desktop computer 100 as shown in FIG. 1A. The desktop computer 100 has a BIOS (not shown), a front panel 100a, a reset button 110, and a power button 120, wherein the reset button 110 and the power button 120 are disposed on the front panel 100a.

The BIOS reset method in the present embodiment includes steps S102˜S122. In step S102, whether the desktop computer 100 is powered off is determined. When it is said that the desktop computer 100 is powered off, it means the desktop computer 100 has shut down the operating system but it does not mean that a motherboard of the desktop computer 100 is not supplied with power. To be specific, the motherboard of the desktop computer 100 in a powered-off status may still be supplied with power through a power supplier of the desktop computer 100. Step S104 is executed, namely, no event takes places, when the desktop computer 100 is not powered off, while step S106 is executed when the desktop computer 100 is powered off.

In step S106, whether the desktop computer 100 is supplied with power is determined. If the desktop computer 100 is not supplied with power, for example, if the power supplier of the desktop computer 100 is unplugged or damaged, the desktop computer 100 is completely powered off. In other words, the desktop computer 100 stops its operation completely if it is not supplied with power. Thus, step S108 is executed, namely, no event takes place, when the desktop computer 100 is not supplied with power, while step S110 is executed when the desktop computer 100 is supplied with power.

The order of foregoing steps S102 and S106 may be switched. To be specific, in another embodiment of the present invention, whether the desktop computer 100 is supplied with power may be determined before whether the desktop computer 100 is powered off is determined.

In step S110, whether the reset button 110 is pressed is determined. Step S112 is executed when the reset button 110 is not pressed, while step S118 is executed when the reset button 110 is pressed.

In step S112, whether the power button 120 is pressed is determined. Step S114 is executed, namely, the desktop computer 100 is booted up, when the power button 120 is pressed, while step S116 is executed, namely, no event takes place, when the power button 120 is not pressed.

In step S118, whether the power button 120 is pressed is determined. Step S120 is executed, namely, no event takes place, when the power button 120 is not pressed, while step S122 is executed when the power button 120 is pressed.

In step S122, the BIOS is reset so as to initialize the value of the BIOS. To be specific, in step S122, an initial value is located into the BIOS. Thus, the value of the BIOS is restored to the original value when the BIOS was just manufactured so that the desktop computer 100 can be booted up normally. In addition, the initial value may be stored in a south bridge (S/B) controller of the desktop computer 100.

FIG. 1C is a circuit diagram of the desktop computer in FIG. 1A, wherein the circuit is suitable for executing foregoing steps S102˜S122. Referring to FIG. 1C, when the desktop computer 100 is powered off and is supplied with power, the reset button 110 is pressed to generate a reset signal, and the reset signal is sent to a decision circuit 130 of the desktop computer 100. Next, the power button 120 is pressed to generate a power signal, and the power signal is sent to the decision circuit 130. The decision circuit 130 determines whether the reset button 110 and the power button 120 are pressed according to whether it receives the reset signal and the power signal.

After the decision circuit 130 receives the reset signal and the power signal, namely, the decision circuit 130 determines that the reset button 110 and the power button 120 are both pressed, the decision circuit 130 issues a command to the S/B controller 140 of the desktop computer 100. After receiving the command, the S/B controller 140 sends the initial value stored therein into the BIOS 150 to load the initial value into the BIOS 150. Accordingly, the BIOS 150 is reset.

As described above, in the present invention, the BIOS of a desktop computer is reset, and accordingly the desktop computer is booted up normally, when a reset button and a power button of the desktop computer are pressed down. Compared to the prior art, the value of the BIOS can be initialized more conveniently and quickly in the present invention. Accordingly, the problem that the desktop computer cannot be booted up can be resolved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for resetting a basic input/output system (BIOS), suitable for a desktop computer having the BIOS, the method comprising:
determining whether the desktop computer is powered off and whether the desktop computer is supplied with power;
determining whether a reset button of the desktop computer is pressed when the desktop computer is powered off and supplied with power;
determining whether a power button of the desktop computer is pressed when the reset button is pressed; and
resetting the BIOS when the reset button and the power button are both pressed.

2. The method according to claim 1, wherein the step of resetting the BIOS comprises:
loading an initial value into the BIOS.

3. The method according to claim 2, wherein the initial value is stored in a south bridge (S/B) controller of the desktop computer.

4. The method according to claim 1, wherein whether the reset button is pressed is determined by a decision circuit of the desktop computer.

5. The method according to claim 1, wherein whether the power button is pressed is determined by a decision circuit of the desktop computer.

6. A method for resetting a BIOS, suitable for a desktop computer being powered off and supplied with power, the desktop computer having the BIOS, the method comprising:
determining whether a reset button of the desktop computer is pressed;
determining whether a power button of the desktop computer is pressed when the reset button is pressed; and
resetting the BIOS when the reset button and the power button are both pressed.

7. The method according to claim 6, wherein the step of resetting the BIOS comprises:
loading an initial value into the BIOS.

8. The method according to claim 7, wherein the initial value is stored in a south bridge (S/B) controller of the desktop computer.

9. The method according to claim 6, wherein whether the reset button is pressed is determined by a decision circuit of the desktop computer.

10. The method according to claim 6, wherein whether the power button is pressed is determined by a decision circuit of the desktop computer.

11. A method for resetting a BIOS, suitable for a desktop computer having the BIOS, the method comprising:
resetting the BIOS when a reset button and a power button of the desktop computer are both pressed.

12. The method according to claim 11, wherein the step of resetting the BIOS comprises:
loading an initial value into the BIOS.

13. The method according to claim 12, wherein the initial value is stored in a south bridge (S/B) controller of the desktop computer.
